(19) United States
(12) Patent Application Publication
(10) Pub. No.: US 2024/0061526 A1
(43) Pub. Date: Feb. 22, 2024

(54) METHOD FOR AN ELECTROLUMINESCENT TOUCH DISPLAY AND AN ELECTROLUMINESCENT TOUCH DISPLAY

(71) Applicant: Lumineq Oy, Espoo (FI)

(72) Inventor: Jussi PIRKKALANIEMI, Mäntsälä (FI)

(73) Assignee: Lumineq Oy, Espoo (FI)

(21) Appl. No.: 18/270,997

(22) PCT Filed: Jan. 20, 2022
(86) PCT No.: PCT/FI2022/050034

§ 371 Date: Jul. 5, 2023

(30) Foreign Application Priority Data
Jan. 21, 2021 (FI) 20215067

(51) Int. Cl. G06F 3/041; G06F 3/044; G09G 3/3208

(52) U.S. Cl. CPC G06F 3/04166; G06F 3/044; G09G 3/3208; G06F 3/0418; G06F 3/0412; G09G 2354/00; G09G 2320/0247

(57) ABSTRACT

A method for driving an electroluminescent touch display (10) is disclosed. The electroluminescent touch display comprises a thin film element (100a) with one or more segment electrodes (107), one or more common electrodes (106), and two or more touch electrodes (101, 101a, 101b). The method comprises a light excitation step (300, 300a, 300b), a touch indication step (320, 320a, 320b), the touch indication step (320, 320a, 320b) comprising detecting if any of the touch electrodes (101, 101a, 101b) is touched, and a touch determination step (310, 310a, 310b), the touch determination step (310, 310a, 310b) comprising determining which of the touch electrodes (101, 101a, 101b) is touched. If none of the touch electrodes (101, 101a, 101b) is touched, the touch determination step (310, 310a, 310b) is left unexecuted. An electroluminescent touch display (10) is also disclosed.

### FIELD OF THE INVENTION

The present invention relates to a method for driving an electroluminescent touch display and more particularly to a method according to preamble of claim 1. The present invention also relates to an electroluminescent touch display and more particularly to an electroluminescent touch display according to preamble of claim 9

### BACKGROUND OF THE INVENTION

In the prior art, touch functionality has been incorporated with electroluminescent displays in various ways. As one approach, touch is sensed with dedicated touch electrodes that are arranged to sense a change in capacitance. In electroluminescent displays, light production is achieved by arranging a luminescent material between electrodes, and by making the material emit light by arranging a voltage over the material by the said electrodes. Said voltage may be a pulsed waveform or a pulsed driving signal as pulsing enables a better control of the brightness of the display through a so-called pulse-width modulation. Some electroluminescent display types, especially the inorganic thin film electroluminescent displays require a pulsed and alternating waveform in which the polarity of the signal changes from one pulse to the next one.

Brightness of the display is another important feature in any practical display device, especially if the display is to be used outdoors in daylight conditions, and the display is transparent. Ambient sunlight through a transparent display makes it challenging to present information as the brightness of the display should match or exceed the brightness of the ambient light to make information visible. A straightforward solution in increasing the brightness is to drive the display with a higher frame rate which is related to increasing the frequency of the driving pulses (and hence, also the frame rate of the display), and this works relatively well if no touch functionality is incorporated to the display.

One of the problems associated with the prior art is that light emission causes interference to the touch sensing as light emission pulses and the spurious electromagnetic coupling to the touch sensing parts can block or hamper the sensing of the real touch events. For this reason, touch sensing and light emission is usually divided or interleaved in separate time periods or timeslots that follow one another repeatedly. This can lower the highest possible frame rate for driving the display, as time periods must be allocated to both touch sensing and light output and thus limit the maximum brightness. As another and likely more serious problem, each of the distinct touch sensitive areas (e.g. buttons or electrodes that are capable of determining a distinct touch event in a certain location of the display) need to be read or scanned separately to determine where, in the area of the display, a touch takes place. This decreases the available frame rate even further, as each of the distinct touch sensitive areas need their own time allocation or period or timeslot for the sensing of the touch. With a touch display with many separate, distinct touch sensing areas or touch electrodes, maximum brightness of the display may not reach the requirements of many relevant use cases, especially outdoor usage of transparent touch displays.

### BRIEF DESCRIPTION OF THE INVENTION

An object of the present invention is to provide a method for driving an electroluminescent display with an increased and improved light production frame rate resulting in a higher maximum brightness, and an electroluminescent touch display with an increased and improved light production frame rate also resulting in a higher maximum brightness.

The objects of the invention are achieved by a method which is characterized by what is stated in the independent claim 1.

The objects of the invention are further achieved by an electroluminescent touch display characterized by what is stated in the independent claim 9.

The preferred embodiments of the invention are disclosed in the dependent claims.

According to an aspect of the present invention, a method for driving an electroluminescent touch display is disclosed. The electroluminescent touch display comprises a thin film element, and the thin film element comprises one or more segment electrodes, one or more common electrodes, and two or more touch electrodes. According to an aspect of the invention, the method comprises: a light excitation step, the light excitation step comprising driving a segment driving signal to the one or more segment electrodes and a common driving signal to the one or more common electrodes, a touch indication step, the touch indication step comprising detecting if any of the two or more touch electrodes is touched, and a touch determination step, the touch determination step comprising determining which of the two or more touch electrodes is touched, such that if any of the two or more touch electrodes is touched as indicated by the touch indication step, the touch determination step is executed, and if none of the two or more touch electrodes is touched as indicated by the touch indication step, the touch determination step is left unexecuted.

Advantage of the method is that the frame rate of the light output, and thus the brightness of the light output, can be increased because the separate touch electrodes are scanned one by one, in the touch determination step, only if any one of them is touched, as indicated in the touch indication step. As touch indication step can be performed essentially as fast as measuring each of the touch electrodes separately, the frame rate of the light output is increased. This leads to improved brightness and more flicker-free operation, and improved responsiveness to touch in the electroluminescent touch display.

In an embodiment, a method for driving an electroluminescent touch display is disclosed wherein the thin film element comprises two or more touch electrode groups, and the two or more touch electrode groups comprise the two or more touch electrodes. In the method, for each of the touch electrode groups, the touch indication step is executed to detect if any of the touch electrodes in the group is touched, such that: if any of the touch electrodes in the group is touched as indicated by the touch indication step, the touch determination step is executed within the group to determine which of the touch electrodes in the group is touched, and if none of the touch electrodes within the group is touched as indicated by the touch indication step, the touch determination step is left unexecuted within the group.

Advantage of this embodiment is that with grouping of the touch electrodes into two or more electrode groups, the time period spent scanning all the touch electrodes of the touch display can be divided into smaller sub periods. Thus, the display may be more responsive, e.g. perform light excitation steps more frequently, or perform interfacing operations to input and output display and touch data more frequently.

In an embodiment, a method for driving an electroluminescent touch display is disclosed wherein the electroluminescent touch display comprises a thin film element, and the thin film element comprises one or more segment electrodes, one or more common electrodes, two or more touch electrodes and two or more touch electrode groups, the two or more touch electrode groups comprising the two or more touch electrodes. In the embodiment, the method comprises: a light excitation step, the light excitation step comprising driving a segment driving signal to the one or more segment electrodes and a common driving signal to the one or more common electrodes, a touch indication step, the touch indication step comprising detecting for each of the touch electrode groups if any of the touch electrodes in the group is touched, and a touch determination step, the touch determination step comprising determining which of the touch electrodes in the group is touched, such that if any of the touch electrodes in the group is touched as indicated by the touch indication step, the touch determination step is executed within the group to determine which of the touch electrodes in the group is touched, and if none of the touch electrodes within the group is touched as indicated by the touch indication step, the touch determination step is left unexecuted within the group.

Advantage of this embodiment is that with grouping of the touch electrodes into two or more electrode groups, the time period spent scanning all the touch electrodes of the touch display can be divided into smaller sub periods. Thus, the display may be more responsive, e.g. perform light excitation steps more frequently, or perform interfacing operations to input and output display and touch data more frequently.

In an embodiment, a method for driving an electroluminescent touch display is disclosed wherein the thin film element comprises two or more segment electrode groups associated with the two or more touch electrode groups. The two or more segment electrode groups comprise the segment electrodes, and in the method, the light excitation step is executed for each of the segment electrode groups before the touch indication step of the touch electrode group associated with the segment electrode group for driving the segment driving signal to the segment electrodes in the segment electrode group and to drive the common driving signal to the one or more common electrodes.

Advantage of the embodiment is that the segment electrodes can be better separated on the thin film element from the touch electrodes for increasing the reliability of the touch sensing due to lessened spurious coupling of segment driving signals fed to the segment electrodes to the touch electrodes.

In an embodiment, a method for driving an electroluminescent touch display is disclosed wherein an area spanned by the touch electrodes of each of the touch electrode groups does not overlap an area spanned by the segment electrodes of each of the associated segment electrode groups. In another embodiment of the method, a smallest distance between an area spanned by the touch electrodes of each of the touch electrode groups and an area spanned by the segment electrodes of each of the associated segment electrode groups is at least 1 mm. In yet another embodiment of the method, a smallest distance between an area spanned by the touch electrodes of each of the touch electrode groups and an area spanned by the segment electrodes of each of the associated segment electrode groups is at least 5 mm.

Advantages of these embodiments are further that the segment electrodes can be better separated on the thin film element from the touch electrodes for increasing the reliability of the touch sensing due to lessened spurious coupling of segment driving signals of the segment electrodes to the touch electrodes.

In an embodiment, a method for driving an electroluminescent touch display is disclosed wherein the thin film element comprises organic luminescent material capable of light production when a voltage exceeding an organic threshold voltage is applied over the organic luminescent material. In another embodiment of the method, the thin film element comprises inorganic luminescent material capable of light production when a voltage exceeding an inorganic threshold voltage is applied over the inorganic luminescent material.

Advantage of these embodiments is that the light output of the display can be controlled with the amplitude of the driving voltage signal, and that different materials can be used to suit the light production needs of the electroluminescent touch display.

In an embodiment, a method for driving an electroluminescent touch display is disclosed wherein the electroluminescent touch display comprises a slider element arranged to input and output level related information, the slider element comprising at least three segment electrodes and at least two touch electrodes.

Sliders are advantageous user interface elements providing both data input and data output that benefit from the increased brightness of the touch display as they are predominantly used in outdoor daylight use conditions.

In an embodiment, a method for driving an electroluminescent touch display is disclosed wherein the electroluminescent touch display comprises a pin-pad element arranged to input and output alphanumeric information, the pin-pad element comprising at least three segment electrodes and at least three touch electrodes. In another embodiment, in the method, the electroluminescent touch display comprises a pin-pad element arranged to input and output alphanumeric information, the pin-pad element comprising at least ten segment electrodes and at least ten touch electrodes. In another embodiment, in the method, the electroluminescent touch display comprises a pin-pad element arranged to input and output alphanumeric information, the pin-pad element comprising at least twelve segment electrodes and at least twelve touch electrodes.

Pin-pads are also advantageous user interface elements providing both data input and data output that benefit from the increased brightness of the touch display as they are predominantly used in outdoor daylight use conditions, especially when pin-pads are arranged as a virtual keyboard on or in a vehicle window.

In an embodiment, a method for driving an electroluminescent touch display is disclosed wherein the thin film element is transparent, or the electroluminescent touch display is transparent. Transparency of the touch display opens up new use cases especially where the touch display may be integrated into or on an existing glazing, e.g. a car side window, architectural safety glass or windshield.

In an embodiment, a method for driving an electroluminescent touch display is disclosed wherein said method is a method for increasing light production frame rate of said electroluminescent touch display.

As an aspect of the invention, an electroluminescent touch display is disclosed. The electroluminescent touch display comprises a thin film element, and the thin film element comprises: one or more segment electrodes, one or more common electrodes, and two or more touch electrodes. The electroluminescent touch display is arranged to drive a segment driving signal to the one or more segment electrodes and to drive a common driving signal to the one or more common electrodes, arranged to detect if any of the two or more touch electrodes is touched, and arranged to determine which of the two or more touch electrodes is touched only if any of the two or more touch electrodes is touched. This may be arranged to increase the light production frame rate of the electroluminescent touch display.

Advantage of the aspect of the invention is that the frame rate of the light output, and thus the brightness of the light output, can be increased because the separate touch electrodes are scanned one by one only if any one of them is touched. This leads to improved brightness and less flicker-free operation.

In an embodiment, the thin film element of the electroluminescent touch display comprises two or more touch electrode groups, the two or more touch electrode groups comprising the two or more touch electrodes, for each of the touch electrode groups, the touch display is arranged to detect if any of the touch electrodes in the group is touched such that if any of the touch electrodes in the group is touched, the electroluminescent touch display is arranged to determine within the group which of the touch electrodes in the group is touched.

Advantage of this embodiment is that with grouping of the touch electrodes into two or more electrode groups, the time period spent scanning all the touch electrodes of the touch display can be divided into smaller sub periods. Thus, the display may be more responsive, e.g. perform light excitation steps more frequently, or perform interfacing operations to input and output touch data more frequently.

In an embodiment, the thin film element of the electroluminescent touch display comprises two or more segment electrode groups associated with the two or more touch electrode groups, the two or more segment electrode groups comprising the segment electrodes, and the electroluminescent touch display is arranged to drive the segment driving signal to the segment electrodes in the segment electrode group and to drive the common driving signal to the one or more common electrodes.

Advantage of the embodiment is that the segment electrodes can be better separated on the thin film element from the touch electrodes for increasing the reliability of the touch sensing due to lessened spurious coupling of segment driving signals fed to the segment electrodes to the touch electrodes.

In an embodiment, an area spanned by the touch electrodes of each of the touch electrode groups does not overlap an area spanned by the segment electrodes of each of the associated segment electrode groups.

In another embodiment, a smallest distance between an area spanned by the touch electrodes of each of the touch electrode groups and an area spanned by the segment electrodes of each of the associated segment electrode groups is at least 1 mm.

In another embodiment, a smallest distance between an area spanned by the touch electrodes of each of the touch electrode groups and an area spanned by the segment electrodes of each of the associated segment electrode groups is at least 5 mm.

Advantages of these embodiments are further that the segment electrodes can be better separated on the thin film element from the touch electrodes for increasing the reliability of the touch sensing due to lessened spurious coupling of segment driving signals of the segment electrodes to the touch electrodes.

In an embodiment, the thin film element comprises organic luminescent material capable of light production when a voltage exceeding an organic threshold voltage is applied over the organic luminescent material.

In an embodiment, the thin film element comprises inorganic luminescent material capable of light production when a voltage exceeding an inorganic threshold voltage is applied over the inorganic luminescent material.

Advantage of these embodiments is that the light output of the display can be controlled with the amplitude of the driving voltage signal, and that different materials can be used to suit the light production needs of the electroluminescent touch display.

In an embodiment, the electroluminescent touch display comprises a slider element arranged to input and output level related information, the slider element comprising at least three segment electrodes and at least two touch electrodes. Sliders are advantageous user interface elements providing both data input and data output that benefit from the increased brightness of the touch display as they are predominantly used in outdoor daylight use conditions.

In an embodiment, the electroluminescent touch display comprises a pin-pad element arranged to input and output alphanumeric information, the pin-pad element comprising at least three segment electrodes and at least three touch electrodes.

In another embodiment, the electroluminescent touch display comprises a pin-pad element arranged to input and output alphanumeric information, the pin-pad element comprising at least ten segment electrodes and at least ten touch electrodes.

In another embodiment, the electroluminescent touch display comprises a pin-pad element arranged to input and output alphanumeric information, the pin-pad element comprising at least twelve segment electrodes and at least twelve touch electrodes.

Pin-pads are also advantageous user interface elements providing both data input and data output that benefit from the increased brightness of the touch display as they are predominantly used in outdoor daylight use conditions.

In another embodiment, the thin film element of the electroluminescent touch display is transparent.

In another embodiment, the electroluminescent touch display is transparent.

Transparency of the touch display or the thin film element of it opens up new use cases especially in use cases where the touch display may be integrated into or on an existing glazing, e.g. a car side window, architectural safety glass or windshield.

In yet another embodiment, the electroluminescent touch display as disclosed by the aspects and embodiments of the electroluminescent touch display above is driven with the method as defined by aspects and embodiments of the method disclosed above.

In yet another embodiment, the electroluminescent touch display is arranged to determine which of the two or more touch electrodes is touched only if any of the two or more touch electrodes is touched to increase the light production frame rate of the electroluminescent touch display.

The invention is based on the idea of first sensing if any of the touch electrodes is touched. If a touch is sensed on the display, only then it is determined which of the touch sensitive areas (e.g. touch electrodes) is touched. Touch sensing circuitry is readily commercially available with the possibility to first identify a touch and only then determine where the touch took place. With this approach, the average frame rate increases as touch identification takes approximately the same time as determination of one touch in one touch sensitive area, e.g. one touch electrode or touch button. Thus, brightness of the display is improved, and the display may avoid flickering due to a too low frame rate.

An advantage of the invention is that touch enabled electroluminescent displays may be operated with a brighter light output and with less flickering. This is especially important when the display is transparent and used in outdoors and daylight conditions, but beneficial for all types of electroluminescent touch displays. With the invention, the touch functionality may also become more responsive. The electroluminescent touch display senses the touch faster and with better reliability.

### BRIEF DESCRIPTION OF THE DRAWINGS

The invention is described in detail by means of specific embodiments with reference to the enclosed drawings, in which

FIG. 1 shows basic units of a prior art electroluminescent touch display,

FIGS. 2a and 2b show a prior art driving method and timing diagram of a prior art electroluminescent touch display,

FIGS. 3a, 3b and 3c show units, a driving method and a timing diagram according to an embodiment of the present invention,

FIGS. 4a and 4b show a driving method and timing diagram according to another embodiment of the present invention,

FIG. 5 shows a driving method according to yet another embodiment of the present invention,

FIGS. 6 and 7 show units and groupings of an electroluminescent touch display according to another embodiment of the present invention,

FIG. 8 shows units of an electroluminescent touch display according to yet another embodiment of the present invention, in particular a so-called slider element, and

FIG. 9 shows units of an electroluminescent touch display according to embodiments the present invention, in particular several pin-pad elements.

### DETAILED DESCRIPTION OF THE INVENTION

In the following description, like numbers (e.g. 210) or labels (e.g. 100a) denote like elements.

The following definitions also apply in the present application throughout:

A “display” means an electronic device configured to present data, state or imagery. The display is arranged to display various patterns as pixels, prefabricated images, or text, but also, for example, indicator displays or user interface elements with at least one emissive area for light emission from the emissive area. In other words, a “display” is arranged to output information through light emission, and it may also input information through a touch functionality.

A “display panel” means the portion of the display, usually a flat, planar sheet of glass on which the light producing and touch sensing electrodes and related connections are arranged. The display panel comprises the at least one light emissive area like one or more overlapping segment electrodes and common electrodes.

A “touch display panel” means the portion of the display which comprises the at least one light emissive area like overlapping segment and common electrodes, and at least one touch sensing area comprising at least one touch electrode.

A “touch display” means a display arranged, in addition to displaying information, to detect user interaction with the display in form of touch or close vicinity relative to the touch display, by part of the body of the user (e.g. finger or elbow) or by a peripheral like a stylus.

An “electroluminescent touch display” means a touch display where the light production is based on electroluminescence. In electroluminescence, a material, usually arranged as a layer, emits light in response to a passage of an electric current through the material or through the layer, or to a suitably strong electric field or voltage over the material or over the layer, from one side of the material to the other, and in particular from one side of the layer to the other side of the layer.

A “touch” means any change in distance between a pointing object, such as a finger of the user of the touch display, and a touch electrode resulting in a detectable change in self-capacitance between said pointing object and said touch electrode. Usually a “touch” means brining the pointing object to a close proximity to the touch electrode, e.g. a situation where only an insulator over the display panel like the interlayer film and glass ply separate the pointing object and the electrode. Such a separation can be, for example 0.5 mm-3 mm. As such, “touch sensing” may herein refer to touch and/or proximity sensing.

A “display element” refers to an element comprising at least one emissive area for emitting light therefrom to present visual information.

“Light” refers to electromagnetic radiation of any wavelength(s) within a range of relevant wavelengths. The range of relevant wavelengths may overlap or coincide with ultraviolet (wavelength from about 10 nanometres (nm) to about 400 nm), visible (wavelength from about 400 nm to about 700 nm), and/or infrared (wavelength from about 700 nm to about 1 millimetre (mm)) parts of electromagnetic spectrum.

A “layer” means a generally sheet-formed element arranged on a surface or a body. A layer can also refer to one of a series of superimposed, overlaid, or stacked generally sheet-formed elements. A layer may generally comprise a plurality of sublayers of different materials or material compositions. A layer may be path-connected. Some layers may be locally path-connected and disconnected and have one or more holes.

A “base plane defining the lateral extension of the thin film element” means that the display element has lateral directions along said base plane. Lateral directions of said element usually have dimensions substantially larger than in a thickness direction perpendicular to said lateral directions.

A “thin film element” refers to a display element comprising layers that have thicknesses, for example, in a range from a few nano metres to some hundreds of nanometres or some micrometres. The thin film display element may also comprise a substrate, substrate usually comprising glass or ceramic material, on top of which the thin films are deposited or otherwise arranged. The thin film display element may also comprise a cover glass on the other side of the substrate.

An “emissive layer” refers to layer comprising material capable of emitting light when a driving signal or driving voltage is coupled over said emissive layer. Here, “over the emissive layer” means that a voltage is applied between the two surfaces of the emissive layer. Said application of voltage is usually arranged by light producing electrodes, in particular segment electrodes and common electrodes arranged on opposite sides of the emissive layer.

A “threshold voltage” means a high enough voltage to achieve a wanted level of light emission from the emissive layer. A threshold voltage in the thin film inorganic electroluminescent displays (also called “TFEL displays”, or “TFELs”) is in the order of 50V-250V in amplitude, and comprise pulses or, in general, AC (alternating current and voltage) excitation. For OLED (organic light emitting diodes or organic LEDs) displays, another important class of emissive displays or electroluminescent displays comprising thin films, the threshold voltage is usually in the range of 0.2-10V only.

A “conductor” may mean an electrical conductor material and/or the electrical conductivity thereof and/or a physical shape (e.g. line or trace) of substantially electrically conducting material. Consequently, a “conductor layer” means a layer comprising a conductor material. A conductor may also mean a cable, e.g. a flat cable or flat printed circuit suitable of conveying one or more voltage or current signals with suitable insulators between the conductive traces or wires.

The concept of “transparent” means a quality, i.e., “transparency”, of said element or material of allowing light of wavelength(s) within a range of relevant wavelengths to propagate through such element or material so that, for example, the sight of vision is not materially hindered with relation to the view behind the material. Said range of relevant wavelengths may generally depend on intended usage of such transparent element or material. No real material is 100% transparent as every material has at least small attenuating and reflective characteristics relative to an ideal free space. Transparency perceived by the sense of vision is usually denoted with a measure called photopic transparency that accounts for the sensitivity of the human eye to different wavelengths and wavelength dependent emissivity of various emissive sources. For transparent electroluminescent touch displays, the photopic transparency may be e.g. 20%-50%.

A “light electrode” or “light producing electrode” means an electrode, usually a planar conductive, thin area or “patch” suitable for coupling electrical voltage or driving signal over an emissive layer for light emission. A display electrode may be functionally, electrically, and/or galvanically connected to a driving electronics unit for the coupling of said electrical voltage. A display electrode may at least partly or entirely overlap another display electrode laterally to couple electrical voltage over an emissive layer. Common electrodes and segment electrodes are both light producing electrodes as their overlapping area, when supplied with a driving signal, produces light according to the principles of TFEL displays or OLED displays.

A “common electrode” is an electrode on one side of the emissive layer that may be common to many segment electrodes on the other side of the emissive layer to provide a lateral overlap of segment electrodes and common electrodes for light production.

A “touch electrode” means an electrode, usually a planar conductive, thin area or “patch” which, when arranged with suitable touch sensing unit or touch measurement unit and touch measurement signals, contributes to sensing a change in capacitance of the touch electrode relative to another electrode or area, surface or object where the electric field lines from the touch electrode start or end, or relative to infinity or other suitably far-away object or location.

A “self-capacitance” of an element means a physical quantity of a non-insulating body, for example a touch electrode, indicative of a ratio between added electrical charge in said body and an increase in electrical potential or voltage of said body. Measurement of self-capacitance may be referred to as measurement of capacitance with respect to infinity. In practice, measurement of self-capacitance may refer to measuring capacitance with respect to an electrical ground, e.g. earth ground.

In the present application, “an electric connection” or “electrical connection” means that two circuit nodes or two circuit elements are arranged to be interconnected purposefully electrically or functionally, and not with just a parasitic coupling between the circuit nodes or circuit elements. The electrical connection may comprise other circuit elements or components in series or in parallel. An electrical connection may also be a short circuit or a low-impedance coupling or a galvanic connection between the two circuit nodes or two circuit elements.

In the present application, a “node” or a “circuit node” means the electric circuit theory concept of a conducting region having essentially the same potential or voltage, between at least two circuit elements. E.g. a conductor (e.g. a copper wire in an FPC) connected to a driving circuit node are the same driving circuit node as the driving circuit node determines the voltage of the conductor throughout the region of the conductor.

In the present application, a “light production frame rate”, or for short, a “frame rate” is a measure of how many times in one second the display light excitation may occur. In many electroluminescent technologies, the light output is based on pulses of light that happen so frequently (so many times in one second) that the sense of vision perceives light output as continuous light. Light pulses from light electrodes (more specifically, from the lateral overlap of common and segment electrodes) are usually arranged so that the driver electronics unit sweeps through all the segment/common electrode pairs by feeding a driving signal thereto one by one (amplitude of the driving signal determining if light is generated or not). Alternatively, driving signals may be fed concurrently to many segment/common electrode pairs. The higher the possible frame rate, in general the brighter the display is. Low frame rates are also disadvantageous as a display may flicker as perceived by the sense of vision. As touch measurements and light output are usually interleaved in time, also touch measurement need time allocation, reducing the highest possible frame rate.

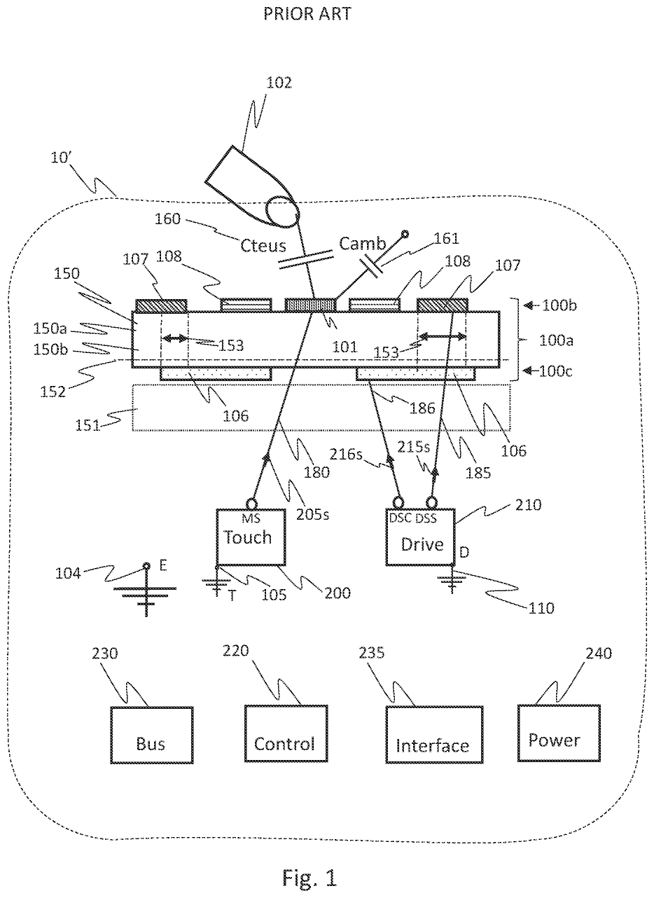

FIG. 1 shows basic units in a prior art electroluminescent touch display 10′ schematically in a side view, cutting plane representation.

The touch display 10′ comprises a thin film element 100a comprising one or more common electrodes 106, and one or more segment electrodes 107. The touch display 10′ may also comprise an emissive layer 150 that, when suitably excited with voltage over the emissive layer, emits light at the lateral overlap 153 of the two electrodes providing the excitation, that is, the lateral overlap 153 of the segment electrodes 107 and common electrodes 106. A touch display 10′ comprises also one or more touch electrodes 101. Furthermore, a touch display 10′ may comprise one or more fill areas 108 which may be arranged between segment electrodes 107 or common electrodes 106 to make the surfaces or layers of the thin film element 100a appear optically more uniform and smooth.

The emissive layer 150 may comprise inorganic material 150b, e.g. manganese doped zinc sulfide (ZnS:Mn) for primarily yellow emission, or terbium doped zinc sulfide (ZnS:Tb) for primarily green emission. These materials are advantageous in inorganic electroluminescent touch displays. These materials may be advantageously deposited e.g. with the atomic layer deposition (ALD) process.

The emissive layer 150 may also comprise organic material 150a, for example organometallic chelates (for example Alq3, Tris(8-hydroxyquinolinato) aluminium) or vinylenes, (for example, polyphenylene vinylene). These materials are advantageous in organic electroluminescent touch displays. These materials may be deposited e.g. with thermal evaporation techniques in vacuum conditions.

Dimensions of the units in FIG. 1 are exaggerated as the thickness of the various electrodes and emissive layer are several orders of magnitude smaller than the thickness and lateral dimensions of the substrate 151, or lateral dimensions of the thin film element 100a.

At the first side of the emissive layer 150, a first patterned conductor layer 100b is provided e.g. by sputtering and etching. At the second side of the emissive layer 150, a second patterned conductor layer 100c is provided e.g. by sputtering and etching. First patterned conductor layer 100b may comprise the segment electrodes 107 and their interconnections to a connection area of the thin film element 100a (interconnections and connection area not shown). The second patterned conductor layer 100c may comprise the one or more common electrodes 106 and also their interconnections to a connection area of the thin film element 100a (interconnections and connection area not shown).

Light emission occurs when light producing electrodes (that is, at least one common electrode 106 and at least one segment electrode 107) are at least partially arranged to overlap in the lateral direction, shown with an imaginary base plane 152, relative to one another, the overlap shown with symbol 153, and when the electrodes 106 and 107 are fed with a common driving signal 216s and a segment driving signal 215s with a high enough amplitude, respectively. The segment driving signal and the common driving signal each have voltage and current characteristics arranged to excite the emissive layer for light emission or leave it dark, depending on the information displaying task at hand. Driving signals are generated by driving electronics unit 210, and each of the common electrodes 106 and each of the segment electrodes 107 are connected to the driving electronics unit 210 with electrical connections 186 and 185, respectively.

If the segment electrodes 107 and common electrodes 106 are transparent, e.g. made of a transparent conductive oxide like indium doped tin oxide (“ITO”), the display is transparent. In TFEL displays, a first electric insulator layer between the segment electrodes 107 and the emissive layer 150 is usually provided. Similarly, in TFEL displays, a second electric insulator layer between the common electrodes 106 and the emissive layer 150 is usually provided. First and second electric insulator layers are provided to block an excessive direct current running through the emissive layer 150, as this would likely ruin the display. First and second insulator layers are usually transparent, as is the emissive layer 150. Thus, the transparency of the display is determined mostly by the properties of the electrode layers (that is, first and second patterned electrode layers).

Purpose of a fill area 108 is to improve the optical appearance and uniformity of the display. Fill areas 108 may be provided to both first patterned conductor layer 100b and second patterned conductor layer 100c. Electrodes (for example, light producing electrodes 106 and 107 and touch electrodes 101) are electrically conductive thin film structures and they do not cover the entire surface area of the display. Transmission and reflectivity at the areas with electrodes and at the areas with no electrodes differ, making the display surface appear nonuniform. This problem can be mostly corrected by deposition (or if the layer is patterned with etching, non-etching) of one or more fill areas 108 that are not fed with driving or measurement signals and are as inert as possible from the standpoint of electrical operation of the display, but from the material and optical point of view correspond or appear like electrodes and are provided from the same conductive material as electrodes, e.g. indium doped tin oxide, ITO. Naturally, there are usually many fill areas 108 in an electroluminescent touch display 10′.

Touch event can be detected when a part, here a finger 102, of the user body is brought to the proximity of touch electrode 101. Also touch electrodes 101 may be provided to both first patterned conductor layer 100b and second patterned conductor layer 100c. User 102 does not need to physically touch the surface of the conducive touch electrode 101 to, as the electrode 101 is usually covered with insulating, protective thin films. Additionally or alternatively, the entire touch display 10′ or at least the thin film element 100a and the related substrate 151 may be embedded, for example, into the interlayer of a laminated vehicle window. However, from the physiological sense, user usually senses a touch, because part of the body of the user (like finger) may physically touch the region in the immediate vicinity of the touch electrode 101, or on the touch electrode 101. Haptic feedback may also be provided by the touch display 10′ (device providing the haptic feedback is not shown in FIG. 1, however).

Detection of touch may be arranged by determining a change of capacitance of the touch electrode 101 caused by the introduction of finger 102 or some other body part of the user, or a peripheral device like stylus held by the user into the vicinity of the touch electrode 101. The finger 102 introduces a parallel capacitance 160 (Cteus) to the system of the touch electrode 101, originally having a capacitance 161 (Camb) relative to the surroundings. Thus, the touch increases the sensed capacitance of the touch electrode 101. With a touch measurement unit 200 and a measurement signal 205s generated and measured by the touch measurement unit 200, the change in the capacitance of the touch electrode 101 is detected. The touch electrode 101 is electrically connected with an electrical connection 180 carrying the touch measurement signal 205s to and from the touch measurement unit 200. For each of the touch electrodes 101, a separate connection 180 to the touch measurement unit 200 may be provided.

FIG. 1 shows also three separate ground nodes, earth ground node 104 which is arranged as the earthing terminal of the touch display, touch electronics ground node 105 which is arranged as a zero reference potential to the touch measurement unit 200 of the touch display, and driving electronics ground node 110 which acts as a zero reference potential to the driving electronics unit 210.

It is evident that a prior art electroluminescent touch display 10′ may comprise a power unit 240 that is arranged to supply power to all the operations of the touch display 10′. Further, the prior art electroluminescent touch display 10′ may comprise an interface unit 235 which is arranged to communicate in two ways with input data and output data (that is, arranged to provide both input and output of data) with the system units external to the prior art touch display 10′ through a communication bus 230. Input data may comprise data on what to show on the display 10′. Input data may represent, directly or indirectly, what light electrodes (e.g. overlapping areas of segment and common electrodes) to set in a light emissive state, and what to keep dark, at any point in time. Output data may comprise data of the touch events and where, on which touch electrode or touch electrodes 101, the touch took place at any point in time.

In the present application, an interface unit 235 means both the physical connector like RJ45 and the related communication protocol like CanBUS, RS485, SPI or I2C. Similarly, communication bus 230 means both the electrical connections, conductors or cabling of the communication bus 230, and the logical protocol like CanBUS or RS485 carried by the electrical connections, conductors and cabling.

The operation of the touch display 10′ may be arranged to be controlled by a control unit 220, which may be arranged to be electrically connected with other units like the touch measurement unit 200, the driving electronics unit 210, the interface unit 235 and the power unit 240. Alternatively, the driving electronics unit 210 or the touch measurement unit 200 may be arranged to control the operation of the touch display 10′.

It is evident for a skilled person that the touch measurement unit 200, driving electronics unit 210, control unit 220, interface unit 235 and power unit 240 can be separate physical entities with their own housing or real estate in a printed circuit board and realized with discrete circuit components. Alternatively or additionally, the touch measurement unit 200, driving electronics unit 210, control unit 220, interface unit 235 and/or power unit 240 can be arranged in part or completely with known integrated circuit technologies into a semiconductor chip, and/or realized programmatically through e.g. ASIC, FPGA and/or microprocessor and memory technologies.

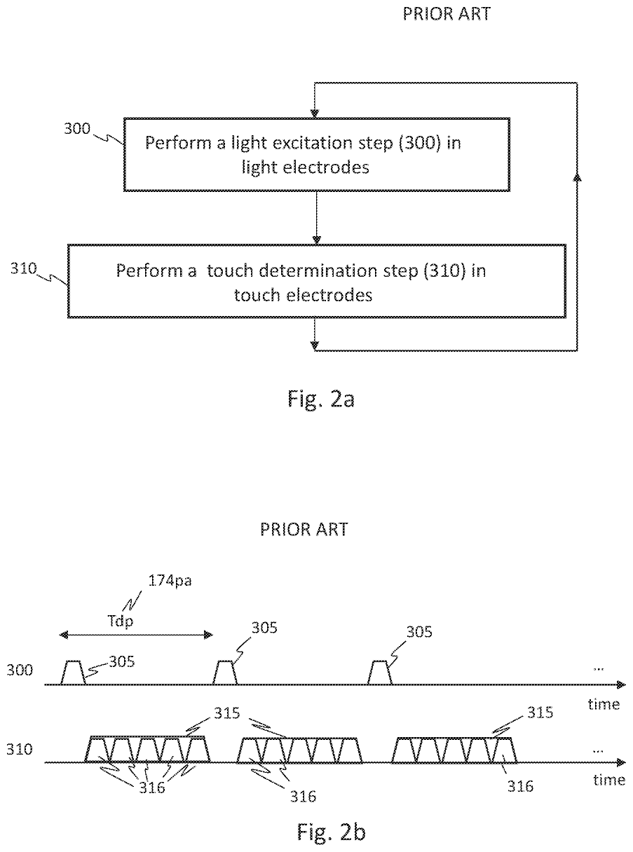

FIG. 2a shows prior art driving and touch measurement method and related steps of a prior art electroluminescent touch display 10′.

In light excitation step 300, a driving voltage pulse or a DC voltage signal is driven or arranged from the driving electronics unit 210 to the one or more segment electrodes 107 and one or more common electrodes 106, and the potential difference between segment driving signal 215s and the common driving signal 216s determines the light output at the area of lateral overlap between the segment and common electrodes. Common driving signal 216s driven to one or more common electrodes 106 may be arranged as a zero potential signal relative to driving electronics ground node 110, or it may be pulsed or a DC signal. If the common driving signal 216s is held at zero potential, segment driving signal 215s driven to one or more segment electrodes 107 alone determines alone light output.

Electroluminescent displays comprise a threshold voltage that must be exceeded between the segment electrode 107 and a common electrode 106 for light output to occur in the emissive layer 150. For inorganic electroluminescent displays, the threshold voltage is typically 140V, and an alternating pulsed signal with an amplitude less than 140V produces no light, when determined between a common electrode 106 and a segment electrode 107. For organic electroluminescent displays, the threshold voltage is in the order of some volts, or even just some desi-volts.

Thus, in light excitation step 300, light output is arranged from the areas of overlap of one or more segment electrodes 107 and one or more common electrodes 106 that, for the purposes of information output, are to be lit at a certain point of time. Similarly, in light excitation step 300, no light output is arranged at areas of overlap of one or more segment electrodes 107 and one or more common electrodes 106 that, for the purposes of information output, are to remain unlit at a certain point of time.

In touch determination step 310, the touch measurement unit 200 is arranged to feed a touch measurement signal 205s to one or more touch electrodes 101 and measure the touch measurement signal 205s to determine a change in the self-capacitance in one or more of the touch electrodes 101. If a change is determined, it may indicate that the one or more touch electrodes is touched. Determination of change of the self-capacitance of a touch electrode 101 may be based on a value or values of self capacitance of a touch electrode 101 indicative of touch not present, said value or values stored in a memory e.g. of a touch measurement unit 200 and measured e.g. immediately after the display 10 is turned on. To determine the change, measured value of the self-capacitance of a touch electrode 101 may compared to the value stored in a memory when the display 10 is operating.

Touch determination step 310 comprises scanning each of the touch electrodes 101 from which touch is to be sensed. Integrated circuits and peripheral components can be arranged to operate as a touch measurement unit 200, and such integrated circuits are readily commercially available, with CY8C4245 family of Cypress Semiconductor Corp (an Infineon Technologies Company) as an example. After the touch determination step, the method starts over or resumes again to perform light excitation in light excitation step 300, and touch determination in touch determination step 310. In this way, dynamic information in form of light and touch functionality can be provided continuously. If steps 300 and 310 are performed fast enough, in the order of at least tens to hundreds of times in one second, human senses perceive an uninterrupted, continuous operation of light production and touch sensing.

FIG. 2b shows prior art driving and touch measurement method and timing diagram and related steps of a prior art electroluminescent touch display 10′. Light excitation step 300 is executed at timepoints indicated with timeslots 305. Separation, in time, of the two timeslots 305 determines the cycle time 174pa (Tdp) of light emission pulses. Inverse f=1/Tdp is the frame rate of the electroluminescent touch display 10′. It is well known that in many electroluminescent display types, brightness of the display is directly proportional to the frame rate of the display. Thus, for maximal brightness of the display, it is advantageous to keep the cycle time 174pa as short as possible, and the frame rate as high as possible. During timeslots 315, the touch determination step 310 is performed. Each of the timeslots 315 indicates the driving and measurement of the touch measurement signal 205s to each of the touch electrodes 101 (in a touch display related to FIG. 2b, there may be five touch electrodes 101) in touch electrode measurement steps during timeslots 316 for determining if a touch in or on each of the touch electrodes 101 has occurred or has not occurred. As shown in FIG. 2b, a touch determination step 310 comprises one or more touch electrode measurement steps during timeslots 316 for each of the touch electrodes 101. In other words, a touch determination step 310 comprises a touch electrode measurement step during a timeslot 316 for all the touch electrodes 101 that are relevant to the operation of the touch display 10′. The timeslots 305 and 316 are indicated to be of same duration in FIG. 2b, but the light excitation step and the touch electrode measurement step or the touch determination step may have a different duration in time, too.

As the light excitation step 300 interferes the touch determination step 310 if they are performed simultaneously due to e.g. electromagnetic coupling of the segment driving signals 215s and common driving signals 216s to the touch electrodes 101 and to touch measurement unit 200, it is advantageous to separate the steps 300 and 310 in time, as show in FIG. 2b. As each of the touch electrode measurement steps during timeslots 316 consumes time, and the duration of the timeslot 315 of the touch determination step 310 is the aggregate of the duration of the timeslots 316 of the touch electrode measurement step, in prior art, the more touch electrodes 101 are measured, the longer the cycle time Tpd gets, resulting in a low frame rate f, and thus, low brightness. Ultimately, if the frame rate gets very low, approximately less than 50 Hz, the display is perceived to flicker. This is a key problem in the prior art electroluminescent touch displays 10′ especially if the number of touch electrodes 101 in the touch display 10′ is high, e.g. more than 5 or more than 15 touch electrodes 101.

Related to FIGS. 2a and 2b, for illustration of various units like segment electrodes 107, common electrodes 106, touch measurement unit 200 and driving electronics unit 210, FIG. 1 is referred.

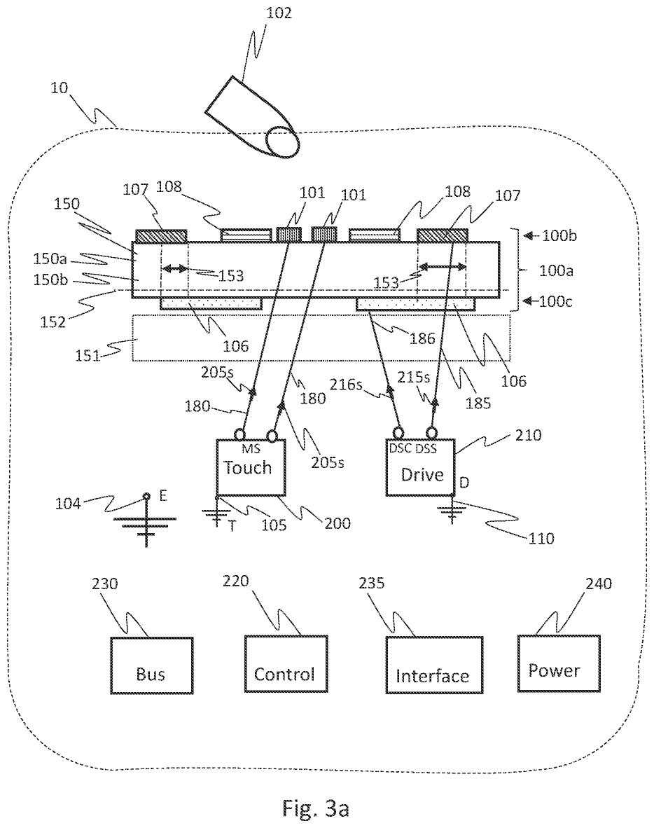

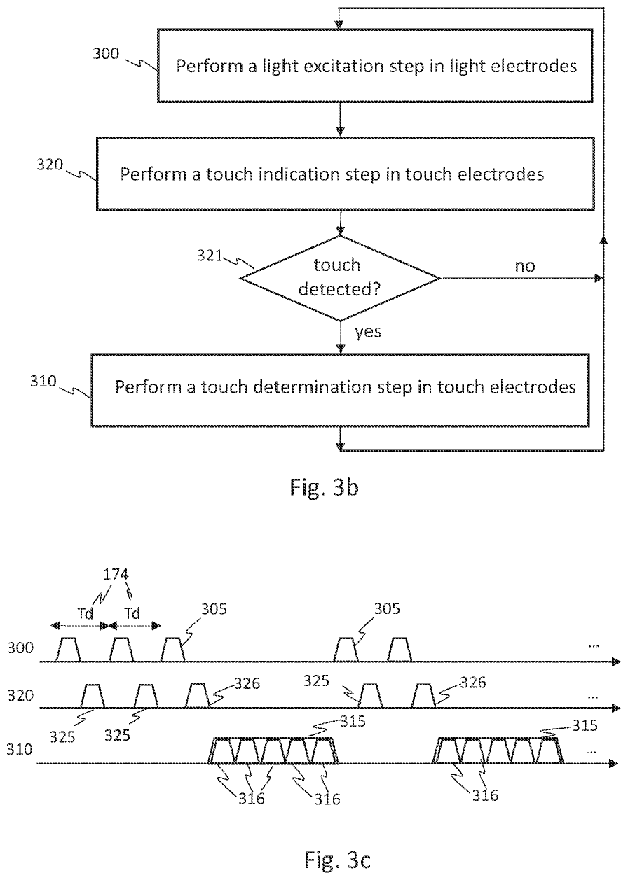

Turning to FIGS. 3a, 3b and 3c, as an aspect of the present invention, a method for increasing light production frame rate of an electroluminescent touch display 10 is disclosed. In the present application, the electroluminescent touch display 10 may also be called “the display” 10 for brevity.

The electroluminescent touch display 10 comprises a thin film element 100a, and the thin film element 100a comprises one or more segment electrodes 107, one or more common electrodes 106, and two or more touch electrodes 101 as indicated in FIG. 3a. For the description of other units in FIG. 3a, description related to FIG. 1 is referred.

Referring in particular to FIG. 3b, according to the invention, the method comprises a light excitation step 300, and the light excitation step 300 comprises driving a segment driving signal to the one or more segment electrodes and a common driving signal 216s to the one or more common electrodes 106. In other words, light excitation step 300 generates light from the areas of segment and common electrode overlaps where light is to be generated at the specific point of time or timeslot. The method comprises also a touch indication step 320, and the touch indication step 320 comprises detecting if any of the two or more touch electrodes 101 is touched. The method also comprises a touch determination step 310, the touch determination step 310 comprising determining which of the two or more touch electrodes 101 is touched, such that:
if any of the two or more touch electrodes 101 is touched as indicated by the touch indication step 320, the touch determination step 310 is executed, and
if none of the two or more touch electrodes 101 is touched as indicated by the touch indication step 320 the touch determination step 310 is left unexecuted.

Thus, with the touch indication step 320, the method detects and decides if the touch determination step 310 is needed. If no touch event is indicated in the touch electrodes 101, the touch determination step 310 can be skipped. This makes it possible to execute the light excitation step 300 more frequently, increasing the brightness and avoiding flickering of the display. With the method, touch indication step 320 may detect simultaneously among all the touch electrodes 101 of the touch display if they are touched, or if any of them is touched. If any one of the touch electrodes 101 is touched, as indicated in decision 321 in FIG. 3b, a touch determination step 310 may then be executed to determine which of the touch electrodes 101 is touched. Thus, the touch indication step 320 may detect touch of any touch electrode 101 simultaneously for all the touch electrodes 101 for the display 10.

After the touch determination step 310, the method resumes in light excitation step 300. If it is determined in the touch indication step 320 that no touch electrodes 101 are touched, a touch determination step 310 may be left unexecuted, that is, it may be skipped, and the method resumes directly in the light excitation step 300. Stated differently, if it is determined in the touch indication step 320 that no touch electrodes 101 are touched among all the touch electrodes 101 of the touch display 10, a touch determination step 310 may be left unexecuted or it may be skipped, and the method resumes directly in the light excitation step 300. Stated still differently, the touch determination step 310 is conditional. The touch determination step 310 is conditional to the detection of touch in any of the touch electrodes 101 in the touch indication step 320, such that if touch in any of the touch electrodes 101 is detected, touch determination step 310 is executed, and otherwise the touch determination step 310 is left unexecuted or skipped. Thus, touch indication step 320 indicates that a touch has occurred in the display 10, and touch determination step 310 determines in which touch electrode 101 the touch has occurred. Touch indication step 320 only produces information on the touch event that some or one of the touch electrodes is touched 101, without information on which of the touch electrodes 101 is touched.

The touch measurement unit 200 may be arranged to perform both touch indication step 320 and touch determination step 310. Integrated circuits that can be arranged to execute both the touch indication step 320 and the touch determination step 310 are commercially available, e.g. as the CY8C4245 family of Cypress Semiconductor Corp (an Infineon Technologies Company). It is obvious that based on a touch determination step 310 and a touch indication step 320, the touch measurement unit 200 may be arranged to communicate e.g. to the interface unit 235 that the display 10 is touched or that a certain touch electrode 101 has been touched, or both. Touch indication step and touch determination step may be based on values of self capacitances indicative of no touch stored in a memory, e.g. into the memory of the touch measurement unit 200, and a change detected in the self capacitances by the touch measurement unit 200 when the touch occurs.

FIG. 3c illustrates the method according to the invention further in form of a timing diagram. In light excitation steps on timeline 300, light excitation steps 300 marked with timeslots 305 are executed more frequently, with a cycle time 174 (Td) when compared to FIG. 2b. This is because in the left portion of the timing diagram, no touch is detected in touch indication steps 320, depicted in timeline 320 and occurring during timeslots 325. Frame rate related to the method is now f=1/Td, Td being the cycle time 174, and when compared to FIG. 2b, the frame rate is higher. Thus, the display is brighter. FIG. 3c also shows how the method resumes with light excitation step 300 after the touch indication step 320 when no touch is detected in the touch electrodes 101.

Touch indication step 320 marked with timeslot 326 detects a touch in one of the all of the touch electrodes 101 of the touch display 10. Because of this, the touch determination step 310 is executed during timeslot 315, and each of the touch electrodes 101 is measured with a touch electrode measurement step, each measurement marked with timeslots 316, to determine which of the touch electrodes 101 is touched. As the duration of one touch indication step 320 may be essentially the same as the duration of one timeslot 316 (and one touch electrode measurement step), the display frame rate is increased owing to the shorter time 174, Td. Only if the touch electrodes 101 are constantly touched, the method does not yield benefits, but this is not a realistic use case.

After touch determination step taking a timeslot 315 to execute, the method resumes with a light excitation step 300 marked with timeslot 305.

Thus, as an advantage of the method, the frame rate of the light output, and thus the brightness of the light output, can be increased because the separate touch electrodes are scanned one by one, in the touch determination step, only if any one of them is touched, as indicated in the touch indication step.

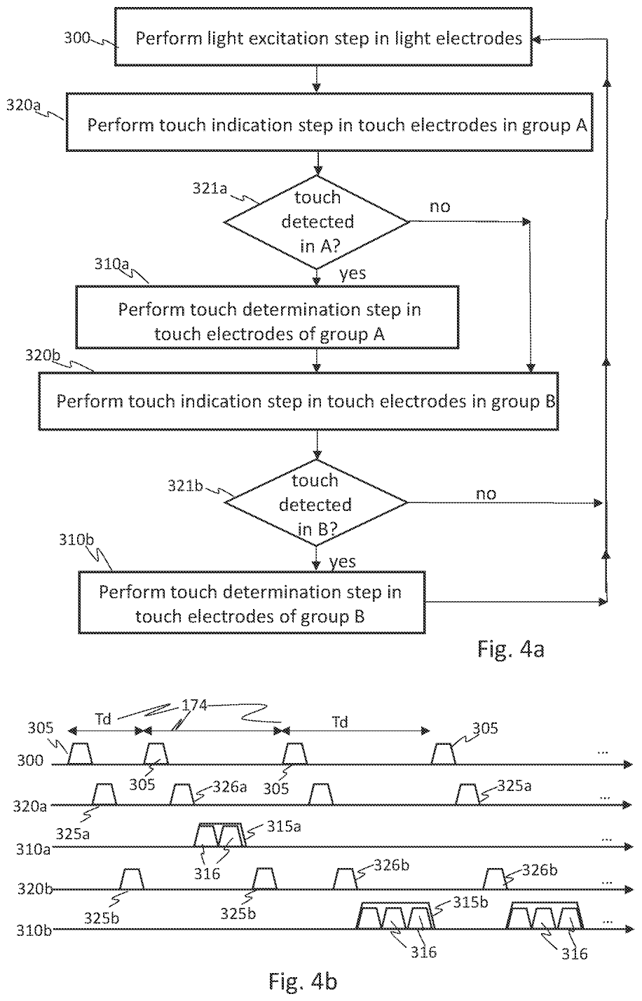

Referring next to FIGS. 4a and 4b, as an embodiment, a method for increasing light production frame rate of an electroluminescent touch display 10 is disclosed. The thin film element 100a comprises two or more touch electrode groups A, B, and the two or more touch electrode groups A, B comprise the two or more touch electrodes 101a, 101b. For each of the touch electrode groups A, B, the touch indication step 320a, 320b is executed to detect if any of the touch electrodes 101a, 101b in the group A, B. In other words, for each of the touch electrode groups A, B, the touch indication step 320a, 320b comprises detecting if any of the touch electrodes 101a, 101b in the group A, B.

In the embodiment of the method,
if any of the touch electrodes 101a, 101b in the group A, B is touched as indicated by the touch indication step 320a, 320b, the touch determination step 310a, 310b is executed within the group A, B to determine which of the touch electrodes 101a, 101b in the group A, B is touched, and
if none of the touch electrodes 101a, 101b within the group A, B is touched as indicated by the touch indication step 320a, 320b, the touch determination step 310a, 310b is left unexecuted within the group A, B.

In other words, in the embodiment of the method,
if any of the touch electrodes 101a, 101b in the group A, B is touched as indicated by the touch indication step 320a, 320b, the touch determination step 310a, 310b comprises determining within the group A, B which of the touch electrodes 101a, 101b in the group A, B is touched, and
if none of the touch electrodes 101a, 101b within the group A, B is touched as indicated by the touch indication step 320a, 320b, the touch determination step 310a, 310b is left unexecuted within the group A, B.

In other words, all the touch electrodes 101 of the display 10 relevant to touch detection are grouped in at least two groups A and B. Touch indication step 320 and the conditional touch determination step 310 is performed group by group. The conditionality is presented with decisions 321a and 321b in FIG. 4a. Touch indication step 320a determines if any of the touch electrodes 101a in group A is touched. The touch indication step 320a may detect touch of any touch electrode 101a simultaneously for all the touch electrodes 101a in group A. If a touch is detected in touch electrodes 101a of group A, a touch determination step 310a is performed to determine which of the touch electrodes 101a in group A is touched. Then, in embodiment, the next touch indication step 320b is executed for the next group B. However, if no touch is detected in touch electrodes 101a of group A, the method continues directly into touch indication step 320b without performing touch determination step 310a, as the touch determination step 310a is not needed because no touch has taken place within the group A. For group B and the touch electrodes 101b within group B, similar steps are repeated. Similarly, if the thin film element comprises more electrode groups C, D etc., similar steps are also repeated there. Finally, after for all the groups, the touch indication step 320 is performed, and if touch is detected within the group, touch determination step 310 is performed to determine which of the touch electrodes 101a, 101b etc. in the group is touched, the method resumes again in the light excitation step 300, and the method loop described above may be executed as long as the display 10 is to operate.

FIG. 4b illustrates the embodiment further. As in FIGS. 2b and 3c, the method steps 300, 310 and 320 are executed during timeslots. During timeslot 305, the light excitation step is executed. During timeslots 325a and 326a, touch indication steps 320a for the touch electrodes 101a in group A are executed. In timeslot 325a, no touch is detected in the touch electrodes 101a in touch indication step 320a, so the touch determination step 310a is left unexecuted as it is conditional. Also no touch is detected in group B in timeslot 325b in the touch electrodes 101b of group B. Thus, the method may resume to light excitation step 300 and next timeslot 305.

In timeslot 326a, touch is detected in at least one touch electrode 101a in group A. Thus, the touch determination step 310a during timeslot 315a is executed, the touch determination step 310a comprising a touch electrode measurement step for each of the touch electrodes 101a in timeslots 316.

In timeslot 325b, no touch is detected in group B, so the method may resume to light excitation step 300 and next timeslot 305.

In timeslot 326b, a touch is detected in at least one touch electrode 101b in group B. Thus, the touch determination step 310b during timeslot 315b is executed, the touch determination step 310b comprising a touch electrode measurement step for each of the touch electrodes 101b in group B in timeslots 316.

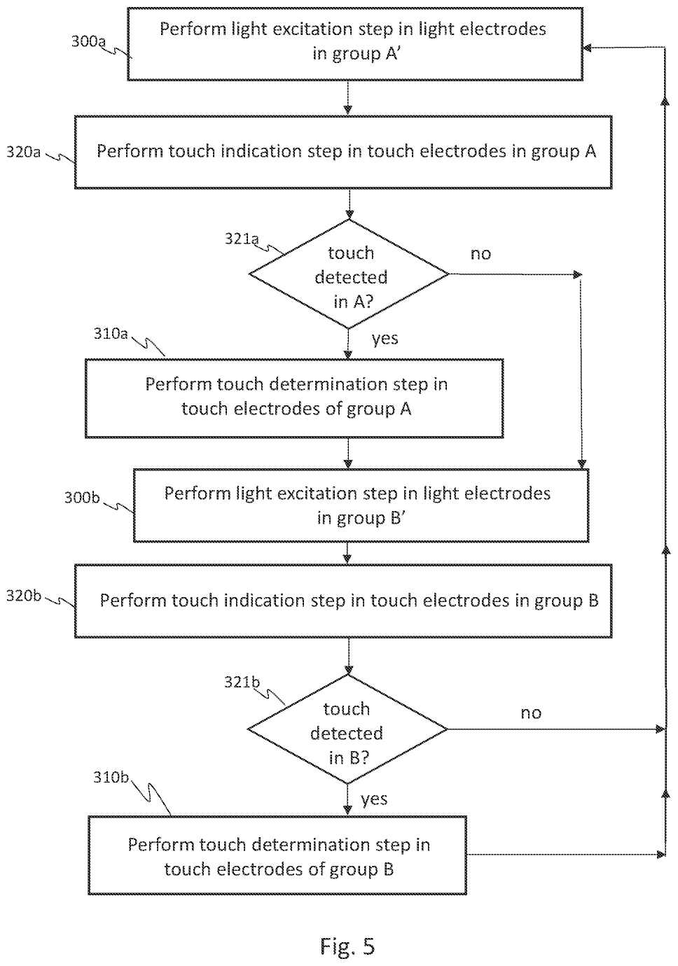

Next turning to FIG. 5, an embodiment of a method for increasing light production frame rate of an electroluminescent touch display 10 is disclosed. As in FIGS. 4a and 4b, the touch electrodes 101a, and 101b may be grouped in at least two groups A and B and then touch indication step 320a, 320b can be performed for each of the groups A and B separately. Further, the thin film element 100a comprises two or more segment electrode groups A′, B′ associated with the two or more touch electrode groups A, B. The two or more segment electrode groups A′, B′ comprise the segment electrodes 107a, 107b. In the embodiment of the method, the light excitation step 300a, 300b is executed for each of the segment electrode groups A′, B′ before the touch indication step 320a, 320b of the touch electrode group A, B. Each of the touch electrode groups A, B is associated with one segment electrode group A′, B′. The light excitation step 300a, 300b is executed for driving the segment driving signal 215s to the segment electrodes 107 in the segment electrode group A′, B′ and to drive the common driving signal 216s to the one or more common electrodes 106.

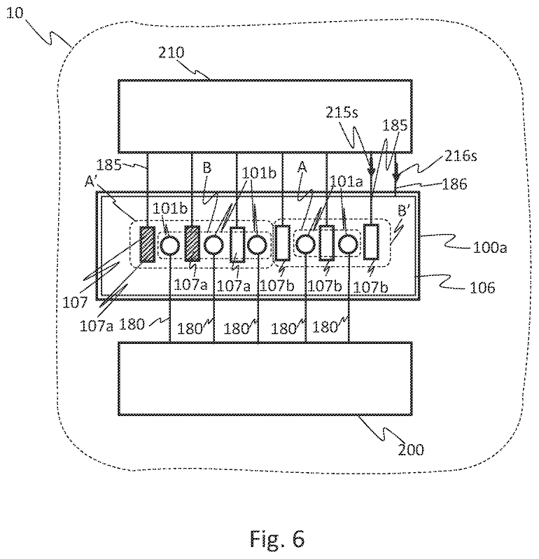

In other words, in an embodiment, segment electrodes 107 may be also grouped into at least two groups A′ and B′. Advantage is that light excitation step 300 can be performed group by group, and thus it may be made shorter. As further shown in FIG. 6, which is an illustration of a display 10 comprising a so-called slider element, the light excitation step may be split for two segment electrode groups A′ and B′ into two, the light excitation step for executing the light excitation in segment electrodes 107a of group A′, and the light excitation step for executing the light excitation in segment electrodes 107b of group B′. Making the group associations of segment electrode groups A′ and touch electrode groups A such that the segment electrodes 107a in group A′ are clearly separated spatially from touch electrodes 101, the interference of light excitation to touch detection may be diminished. The same holds for segment electrode group B′ and touch electrode group B, and for possible other groups C and C′. After the touch indication and conditional touch determination are executed for the last step, the method of the embodiment may resume again for the first light excitation step 300a for the first group A′, and the same method loop may be executed as long as the display 10 is to operate.

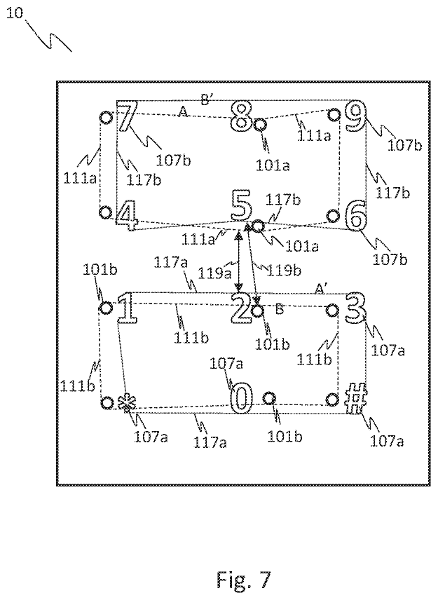

Turning to FIG. 7, as an embodiment of a method for increasing light production frame rate of an electroluminescent touch display 10, a top view of a display 10 is shown. FIG. 7 shows a so-called pin-pad display with 12 segment electrodes 107a, 107b for light output indicating alphanumeric information, and 12 touch electrodes 101a, 101b for detecting touch in the immediate vicinity of the segment electrodes (not all touch electrodes are shown). To diminish the detrimental coupling of the light emission from the touch measurements comprising a touch determination step and a touch indication step, it is advantageous to spatially separate the touch electrodes 101a, 101b from the segment electrodes 107a, and 107b, respectively. The touch electrode group A comprises touch electrodes 101a that span an area 111a, marked with a dashed line and symbol A, as shown at the upper side of the display 10. Segment electrode group A′ comprises segment electrodes 107a, as shown at the lower side of the display 10. Segment electrodes 107a span an area 117a, marked with dotted line and symbol A′. The touch electrodes 101a in touch electrode group A and segment electrodes 107a in the associated segment electrode group A′ are clearly separated and thus any interference between the two electrode types is diminished. Similarly, touch electrode group B (at the lower side of display 10) comprises touch electrodes 101b that span an area 111b, marked with a dashed line and symbol B. Segment electrode group B′ comprises segment electrodes 107b, as shown at the upped side of the display 10. Segment electrodes 107b span an area 117b, marked with dotted line and symbol B′. The touch electrodes 101b in touch electrode group B and segment electrodes 107b in the associated segment electrode group B′ are again clearly separated and thus any interference between the two electrode types is diminished.

Thus, still referring still to FIG. 7, in an embodiment, an area 111a, 111b spanned by the touch electrodes 101a, 101b of each of the touch electrode groups A, B does not overlap an area 117a, 117b spanned by the segment electrodes 107a, 107b of each of the associated segment electrode groups A′, B′. This is the case in FIG. 7, as there is a clear separation 119a, 119b between a touch electrode group (A or B) and its associated segment electrode group (A′ or B′).

In another embodiment, still referring to FIG. 7, a smallest distance 119a, 119b between an area 111a, 111b spanned by the touch electrodes 101a, 101b of each of the touch electrode groups A, B and an area 117a, 117b spanned by the segment electrodes 107a, 107b of each of the associated segment electrode groups A′, B′ is at least 1 mm. In FIG. 7, distance 119a is the smallest distance between the touch electrode group A and associated segment electrode group A′, and distance 119b is the smallest distance between the touch electrode group B and associated segment electrode group B′. Both distances 119a and 119b may be at least 1 mm.

In another embodiment, still referring to FIG. 7, a smallest distance 119a, 119b between an area 111a, 111b spanned by the touch electrodes 101a, 101b of each of the touch electrode groups A, B and an area 117a, 117b spanned by the segment electrodes 107a, 107b of each of the associated segment electrode groups A′, B′ is at least 5 mm. In FIG. 7, distance 119a is the smallest distance between the touch electrode group A and associated segment electrode group A′, and distance 119b is the smallest distance between the touch electrode group B and associated segment electrode group B′. Both distances 119a and 119b may be at least 5 mm.

In an embodiment of the method for increasing light production frame rate of an electroluminescent touch display 10, the thin film element 100a comprises organic luminescent material 150a capable of light production when a voltage exceeding an organic threshold voltage is applied over the organic luminescent material 150a. For the thin film element 100a and material 150a, FIG. 3a is referred. Organic luminescent material 150a may have an organic threshold voltage of some volts, e.g. 2V or 4V, or some desivolts, e.g. 0.8V. The voltage over the material is defined as a voltage from a segment electrode 107 to a common electrode 106 either with positive polarity or negative polarity. Organic luminescent material 150a may comprise, for example, an organometallic chelate (for example Alq3, Tris(8-hydroxyquinolinato) aluminium) or a vinylene, (for example, polyphenylene vinylene). The organic threshold voltage over the material is defined as a voltage from a segment electrode 107 to a common electrode 106 either with positive polarity or negative polarity.

In another embodiment of the method, the thin film element 100a comprises inorganic luminescent material 150b capable of light production when a voltage exceeding an inorganic threshold voltage is applied over the inorganic luminescent material 150b. Again, for the thin film element 100a and material 150b, FIG. 3a is referred. Inorganic luminescent material 150a may have an inorganic threshold voltage of many tens or over hundred volts, e.g. 55V or 140V. Inorganic luminescent material may comprise, for example manganese doped zinc sulfide (ZnS:Mn) or terbium doped zinc sulfide (ZnS:Tb). The inorganic threshold voltage over the material is defined as a voltage from a segment electrode 107 to a common electrode 106 either with positive polarity or negative polarity.

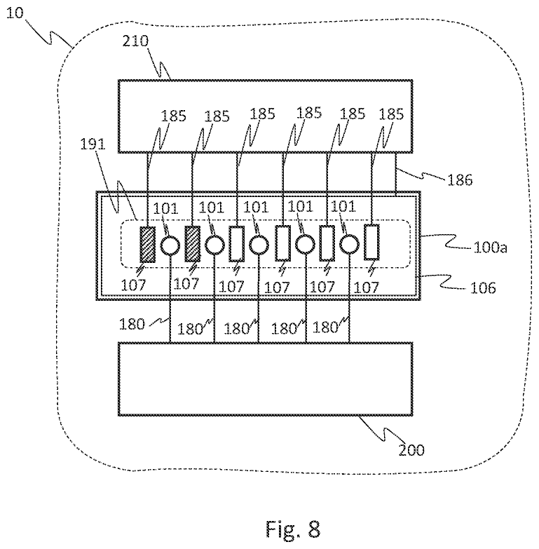

Referring next to FIG. 8, in an embodiment of the method for increasing light production frame rate of an electroluminescent touch display 10, the electroluminescent touch display 10 comprises a slider element 191 arranged to input and output level related information. The slider element 191 comprises at least three segment electrodes 107 and at least two touch electrodes 101. In Figure, there are six segment electrodes 107 and five touch electrodes 101. When user moves his finger or otherwise touches the touch electrodes 101 of the display 10, a certain level can be determined from the user action, and this level can be indicated by lighting a number of adjacent light electrodes (that is, overlapping segment electrodes 107 and common electrodes 106). In a slider element 191, segment electrodes 107 and touch electrodes 101 are arranged to be interleaved spatially. In FIG. 8, there are two segment electrodes 107 lit, indicated by a diagonal hatching. Maximum level would be indicated by six segment electrodes 107 lit. By sliding e.g. finger of the user on the touch display 10 and its touch electrodes 101, a mechanical slide element like sliding potentiometer may be imitated as the various touch electrodes 101 may determine the position of the touch over the slider element 191.

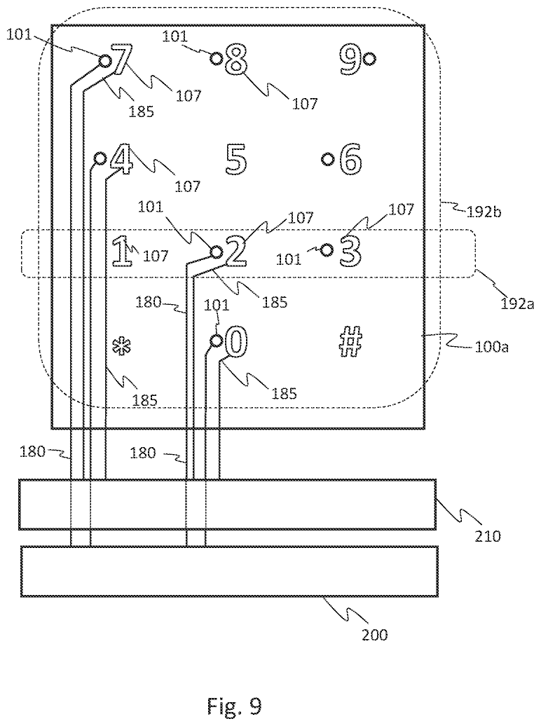

Next turning to FIG. 9, as an embodiment of a method for increasing light production frame rate of an electroluminescent touch display 10, the electroluminescent touch display 10 comprises a pin-pad element 192a arranged to input and output alphanumeric information. The pin-pad element 192a comprises at least three segment electrodes 107 and at least three touch electrodes 101. A pin-pad element according to his embodiment may be used such that the display 10 is integrated into a window of a vehicle, and the display 10 is arranged to input an entry code to unlock one or more doors of the vehicle. With three or more segment and touch electrodes, an elegant and small pin-pad can be provided for the limited space in a vehicle window, e.g. back quarter panel window, and an increased brightness is advantageous in vehicle applications that operate outdoors in daylight conditions.

Still related to FIG. 9, in another embodiment of a method for increasing light production frame rate of an electroluminescent touch display 10, the electroluminescent touch display 10 comprises a pin-pad element 192b arranged to input and output alphanumeric information. The pin-pad element 192b comprises at least ten segment electrodes 107 and at least ten touch electrodes 101. With ten or more segment and touch electrodes, a pin-pad with digits 0-9 can be provided, and an increased brightness is advantageous in vehicle applications that operate outdoors in daylight conditions.

In yet another embodiment of a method for increasing light production frame rate of an electroluminescent touch display 10, and still referring to in FIG. 9, the electroluminescent touch display 10 comprises a pin-pad element 192b arranged to input and output alphanumeric information. The pin-pad element 192b comprises at least twelve segment electrodes 107 and at least twelve touch electrodes 101. With twelve or more segment and touch electrodes, a pin-pad with digits 0-9 can be provided with extra touch elements like asterisk and hash for added functionality, and an increased brightness is advantageous in vehicle applications that operate outdoors in daylight conditions.

In an embodiment, a method for increasing light production frame rate of an electroluminescent touch display 10 is disclosed where the thin film element 100a is transparent. Transparency can be arranged by making the various layers of the thin film element transparent, as the substrate 151 can comprise glass and is thus transparent. Various materials of the emissive layer 150 like ZnS:Mn are transparent if arranged to thin, yet practical thicknesses of some 100s of nano-meters. Also additional layers, like electrically insulating layers around the emissive layer 150 are transparent. The transparency of the thin film element 100a is mostly determined by the electrodes, touch electrodes 101, segment electrodes 107 and common electrodes 106, and their associated traces and interconnections for driving and touch measurement signal feeding. By arranging the electrodes 101, 106 and 107 with ITO, indium doped tin oxide or some other transparent oxide, practical transparency with a photopic transparency through the entire display 10 of 20% or better can be achieved.

In another embodiment, the electroluminescent touch display (10) is transparent. Transparency for the display can be provided as with the transparency of the thin film element 100a by arranging the thin film element 100a on a transparent substrate 151.

Referring back to FIG. 6, as an aspect of the present invention, an electroluminescent touch display 10 is disclosed. The electroluminescent touch display 10 comprises a thin film element 100a, and the thin film element 100a comprises one or more segment electrodes 107, one or more common electrodes 106, and two or more touch electrodes 101, 101a, 101b. In the aspect of the invention, the electroluminescent touch display 10 is arranged to drive a segment driving signal 215s to the one or more segment electrodes 107 and to drive a common driving signal 216s to the one or more common electrodes 106. The electroluminescent display 10 is also arranged to detect if any of the two or more touch electrodes 101, 101a, 101b is touched, and arranged to determine which of the two or more touch electrodes 101, 101a, 101b is touched only if any of the two or more touch electrodes 101, 101a, 101b is touched to increase the light production frame rate of the electroluminescent touch display 10.

In other words, the electroluminescent touch display 10 may be arranged to detect a touch among any of all the touch electrodes 101, and only if a touch among any of all the touch electrodes 101, 101a, 101b is detected, the display 10 is arranged to detect the specific touch electrode 101, 101a, 101b which is touched. This makes the operations of the display 10 faster and the output brighter due to an increased frame rate, and responsiveness to touch better. Thus, the determination of which of the two or more touch electrodes 101, 101a, 101b is touched is conditional to first detecting that any one of them is touched. The detection if any of the two or more touch electrodes 101, 101a, 101b is touched may be arranged to be executed simultaneously for all the touch electrodes 101, 101a, 101b of the display 10. Thus, detecting that any of the touch electrodes 101, 101a, 101b is touched may be arranged to be separate to detecting which of the touch electrodes 101a, 101b, 101c is touched.

Detecting if any of the two or more touch electrodes 101, 101a, 101b is touched and detecting which of the two or more touch electrodes 101, 101a, 101b is touched may be arranged with off-the-shelf touch IC components and related peripheral components, e.g. with the CY8C4245 family of Cypress Semiconductor Corp (an Infineon Technologies Company). It is obvious that the touch measurement unit 200 may be arranged to communicate e.g. to the interface unit 235 that the display 10 is touched or that a certain touch electrode 101 has been touched, or both.

Still referring to FIG. 6, in an embodiment, the thin film element 100a of the electroluminescent touch display 10 comprises two or more touch electrode groups A, B, the two or more touch electrode groups A, B comprising the two or more touch electrodes 101. For each of the touch electrode groups A, B, the electroluminescent touch display 10 is arranged to detect if any of the touch electrodes in the group A, B is touched. This is arranged such that if any of the touch electrodes 101a, 101b in the group A, B is touched, the electroluminescent touch display 10 is arranged to determine within the group A, B which of the touch electrodes 101a, 101b in the group A, B is touched.

In other words, all the touch electrodes 101 of the display 10 relevant to touch detection are grouped in at least two groups A and B. The display 10 is arranged to detect if any of the touch electrodes 101 in group A is touched. This may be arranged to be executed simultaneously for all of the touch electrodes 101a in group A. If a touch is detected in touch electrodes 101a of group A, the display 10 is arranged determine which of the touch electrodes 101 in group A is touched. Thus, the display 10 is arranged determine which of the touch electrodes 101 in group A is touched conditionally. Conditionality is arranged and based on the result of detecting if any of the touch electrodes 101 in group A is touched.

For group B and the touch electrodes 101b within group B, the display 10 is arranged to operate similarly as with touch electrodes 101a and touch electrode group A. This holds also for any further touch electrode groups C, D etc. the display 10 may comprise.

In an embodiment, the thin film element 100a of the electroluminescent touch display 10 comprises two or more segment electrode groups A′, B′ associated with the two or more touch electrode groups A, B. The two or more segment electrode groups A′, B′ comprise the segment electrodes 107. The electroluminescent touch display 10 is arranged to drive the segment driving signal 215s to the segment electrodes 107 in the segment electrode group A′, B′ and to drive the common driving signal 216s to the one or more common electrodes 106. Making the group associations of segment electrode groups A′ and touch electrode groups A such that the segment electrodes 107a in group A′ are clearly separated spatially from touch electrodes 101a in touch electrode group A, the interference of light excitation to touch detection may be diminished. The same holds for touch electrode group B and segment electrode group B′.

Next referring to FIG. 7, in an embodiment, in the electroluminescent touch display 10 an area 111a, 111b spanned by the touch electrodes 101a, 101b of each of the touch electrode groups A, B does not overlap an area 117a, 117b spanned by the segment electrodes 107a, 107b of each of the associated segment electrode groups A′, B′. This is the case in FIG. 7, as there is a clear separation 119a, 119b between a touch electrode group (A or B, respectively) and its associated segment electrode group (A′ or B′, respectively).

Still referring to FIG. 7, in an embodiment, in the electroluminescent touch display 10, the smallest distance 119a, 119b between an area 111a, 111b spanned by the touch electrodes 101a, 101b of each of the touch electrode groups A, B and an area 117a, 117b spanned by the segment electrodes 107a, 107b of each of the associated segment electrode groups A′, B′ is at least 1 mm. In FIG. 7, distance 119a is the smallest distance between the touch electrode group A and the associated segment electrode group A′, and distance 119b is the smallest distance between the touch electrode group B and associated segment electrode group B′. Both distances 119a and 119b may be at least 1 mm.

Referring to FIG. 7, in an embodiment, in the electroluminescent touch display 10, the smallest distance 119a, 119b between an area 111a, 111b spanned by the touch electrodes 101a, 101b of each of the touch electrode groups A, B and an area 117a, 117b spanned by the segment electrodes 107a, 107b of each of the associated segment electrode groups A′, B′ is at least 5 mm. In FIG. 7, distance 119a is the smallest distance between the touch electrode group A and the associated segment electrode group A′, and distance 119b is the smallest distance between the touch electrode group B and associated segment electrode group B′. Both distances 119a and 119b may be at least 5 mm.

In an embodiment, the thin film element 100a of the electroluminescent touch display 10 comprises organic luminescent material 150a capable of light production when a voltage exceeding an organic threshold voltage is applied over the organic luminescent material 150a. For the thin film element 100a and material 150a, FIG. 3a is referred. Organic luminescent material 150a may have an organic threshold voltage of some volts, e.g. 2V or 4V, or some desivolts, e.g. 0.8V. The voltage over the material is defined as a voltage from a segment electrode 107 to a common electrode 106 either with positive polarity or negative polarity. Organic luminescent material 150a may comprise, for example, an organometallic chelate (for example Alq3, Tris(8-hydroxyquinolinato)aluminium) or a vinylene, (for example, polyphenylene vinylene).

In another embodiment, the thin film element 100a of the electroluminescent touch display 10 comprises inorganic luminescent material 150b capable of light production when a voltage exceeding an inorganic threshold voltage is applied over the inorganic luminescent material 150b. Again, for the thin film element 100a and material 150b, FIG. 3a is referred. Inorganic luminescent material 150a may have an inorganic threshold voltage of many tens or over hundred volts, e.g. 55V or 140V. Inorganic luminescent material may comprise, for example manganese doped zinc sulfide (ZnS:Mn) or terbium doped zinc sulfide (ZnS:Tb). The voltage over the material is defined as a voltage from a segment electrode 107 to a common electrode 106 either with positive polarity or negative polarity.

Referring back to FIG. 8, in an embodiment, the electroluminescent touch display 10 comprises a slider element 191 arranged to input and output level related information. The slider element 191 comprises at least three segment electrodes 107 and at least two touch electrodes 101. In a slider element 191, segment electrodes 107 and touch electrodes 101 are arranged to be interleaved spatially. In Figure, there are six segment electrodes 107 and five touch electrodes 101. When user moves his finger or otherwise touches the touch electrodes 101 of the display 10, a certain level can be determined from the user action, and this level can be indicated by lighting a number of adjacent light electrodes (that is, overlapping segment electrodes 107 and common electrodes 106). In FIG. 8, there are two segment electrodes 107 lit, indicated by a diagonal hatching. Maximum level would be indicated by six segment electrodes 107 lit. By sliding e.g. finger of the user on the touch display 10 and its touch electrodes 101, a mechanical slide element like sliding potentiometer may be imitated as the various touch electrodes 101 may determine the position of the touch over the slider element 191.

Next turning to FIG. 9, as an embodiment, the electroluminescent touch display 10 comprises a pin-pad element 192a arranged to input and output alphanumeric information. The pin-pad element 192a comprises at least three segment electrodes 107 and at least three touch electrodes 101. A pin-pad element according to his embodiment may be used such that the display 10 is integrated into a window of a vehicle, and the display 10 is arranged to input an entry code to unlock one or more doors of the vehicle. With three or more segment and touch electrodes, an elegant and small pin-pad can be provided for the limited space in a vehicle window, e.g. back quarter panel window, and an increased brightness is advantageous in vehicle applications that operate outdoors in daylight conditions.

Still related to FIG. 9, in another embodiment, the electroluminescent touch display 10 comprises a pin-pad element 192b arranged to input and output alphanumeric information. The pin-pad element 192b comprises at least ten segment electrodes 107 and at least ten touch electrodes 101. With ten or more segment and touch electrodes, a pin-pad with digits 0-9 can be provided, and an increased brightness is advantageous in vehicle applications that operate outdoors in daylight conditions.

In yet another embodiment and still referring to in FIG. 9, the electroluminescent touch display 10 comprises a pin-pad element 192b arranged to input and output alphanumeric information. The pin-pad element 192b comprises at least twelve segment electrodes 107 and at least twelve touch electrodes 101. With twelve or more segment and touch electrodes, a pin-pad with digits 0-9 can be provided with extra touch elements like asterisk and hash for added functionality, and an increased brightness is advantageous in vehicle applications that operate outdoors in daylight conditions.

In an embodiment, the electroluminescent touch display 10 comprises a transparent thin film element 100a. Transparency can be arranged by making the various layers of the thin film element transparent, as the substrate 151 can comprise glass and is thus transparent. Various emissive layer materials like ZnS:Mn are transparent if arranged to thin, yet practically operable thicknesses of some 100s of nano-meters. Also additional layers, like electrically insulating layers around the emissive layer 150 are transparent. The transparency of the thin film element 100a is mostly determined by the electrodes, touch electrodes 101, segment electrodes 107 and common electrodes 106, and their associated traces and interconnections for driving and touch measurement signal feeding. By providing the electrodes 101, 106 and 107 e.g. with ITO, indium doped tin oxide or some other transparent oxide, practical transparency with a photopic transparency through the entire display 10 of 20% or better can be achieved.

In another embodiment, the electroluminescent touch display 10 is transparent. Transparency for the display can be provided as with the transparency of the thin film element 100a e.g. by arranging the thin film element 100a on a transparent substrate 151.

In another embodiment, the electroluminescent touch display 10 is driven with the method as defined in the above description. Driving an electroluminescent touch display 10, in the present application means any operation of the display 10, in particular both driving a segment driving signal 215s and common driving signal 216s to the display, to the segment electrodes 107 and common electrodes 106, and also detecting touches in touch electrodes 101 e.g. in touch indication steps and touch determination steps with a touch measurement unit 200 and measurement signals 205s generated and measured by the touch measurement unit 200.

The invention has been described above with reference to the examples shown in the figures. However, the invention is in no way restricted to the above examples but may vary within the scope of the claims.

1. A method for driving an electroluminescent touch display, the electroluminescent touch display comprising a thin film element, the thin film element comprising:
one or more segment electrodes,
one or more common electrodes, and
two or more touch electrodes, the method comprises:
a light excitation step, the light excitation step comprising driving a segment driving signal to the one or more segment electrodes and a common driving signal to the one or more common electrodes,
a touch indication step, the touch indication step comprising detecting if any of the two or more touch electrodes is touched, and
a touch determination step, the touch determination step comprising determining which of the two or more touch electrodes is touched, such that
if any of the two or more touch electrodes is touched as indicated by the touch indication step, the touch determination step is executed, and
if none of the two or more touch electrodes is touched as indicated by the touch indication step, the touch determination step is left unexecuted.

2. A method for driving an electroluminescent touch display according to claim 1, wherein
the thin film element comprises two or more touch electrode groups (A, B), the two or more touch electrode groups (A, B) comprising the two or more touch electrodes, and in that
in the method, for each of the touch electrode groups (A, B), the touch indication step is executed to detect if any of the touch electrodes in the group (A, B) is touched, such that:
if any of the touch electrodes in the group (A, B) is touched as indicated by the touch indication step, the touch determination step is executed within the group (A, B) to determine which of the touch electrodes in the group (A, B) is touched, and
if none of the touch electrodes within the group (A, B) is touched as indicated by the touch indication step, the touch determination step is left unexecuted within the group (A, B).

3. A method for driving an electroluminescent touch display according to claim 2, wherein
the thin film element comprises two or more segment electrode groups (A′, B′) associated with the two or more touch electrode groups (A, B), the two or more segment electrode groups (A′, B′) comprising the segment electrodes, and
in the method, the light excitation step is executed for each of the segment electrode groups (A′, B′) before the touch indication step of the touch electrode group (A, B) associated with the segment electrode group (A′, B′) for driving the segment driving signal to the segment electrodes in the segment electrode group (A′, B′) and to drive the common driving signal to the one or more common electrodes.

4. A method for driving an electroluminescent touch display according to claim 3, wherein
an area spanned by the touch electrodes of each of the touch electrode groups (A, B) does not overlap an area spanned by the segment electrodes of each of the associated segment electrode groups (A′, B′); or
a smallest distance between an area spanned by the touch electrodes of each of the touch electrode groups (A, B) and an area spanned by the segment electrodes of each of the associated segment electrode groups (A′, B′) is at least 1 mm; or
a smallest distance between an area spanned by the touch electrodes of each of the touch electrode groups (A, B) and an area spanned by the segment electrodes of each of the associated segment electrode groups (A′, B′) is at least 5 mm.

5. A method for driving an electroluminescent touch display according to claim 1, wherein
the thin film element comprises organic luminescent material capable of light production when a voltage exceeding an organic threshold voltage is applied over the organic luminescent material; or
the thin film element comprises inorganic luminescent material capable of light production when a voltage exceeding an inorganic threshold voltage is applied over the inorganic luminescent material.

6. A method for driving an electroluminescent touch display according to claim 1, wherein the electroluminescent touch display comprises a slider element arranged to input and output level related information, the slider element comprising at least three segment electrodes and at least two touch electrodes.

7. A method for driving an electroluminescent touch display according to claim 1, wherein:
the electroluminescent touch display comprises a pin-pad element arranged to input and output alphanumeric information, the pin-pad element comprising at least three segment electrodes and at least three touch electrodes; or
the electroluminescent touch display comprises a pin-pad element arranged to input and output alphanumeric information, the pin-pad element comprising at least ten segment electrodes and at least ten touch electrodes; or
the electroluminescent touch display comprises a pin-pad element arranged to input and output alphanumeric information, the pin-pad element comprising at least twelve segment electrodes and at least twelve touch electrodes.

8. A method for driving an electroluminescent touch display according to claim 1, wherein:
the thin film element is transparent; or
the electroluminescent touch display is transparent.

9. An electroluminescent touch display, the electroluminescent touch display comprising a thin film element, the thin film element comprising:
one or more segment electrodes,
one or more common electrodes, and
two or more touch electrodes, the electroluminescent touch display is:
arranged to drive a segment driving signal to the one or more segment electrodes and to drive a common driving signal to the one or more common electrodes,
arranged to detect if any of the two or more touch electrodes is touched, and
arranged to determine which of the two or more touch electrodes is touched only if any of the two or more touch electrodes is touched.

10. An electroluminescent touch display according to claim 9, wherein
the thin film element comprises two or more touch electrode groups (A, B), the two or more touch electrode groups (A, B) comprising the two or more touch electrodes,
for each of the touch electrode groups (A, B), the touch display is arranged to detect if any of the touch electrodes in the group (A, B) is touched such that:
if any of the touch electrodes in the group (A, B) is touched, the electroluminescent touch display is arranged to determine within the group (A, B) which of the touch electrodes in the group (A, B) is touched.

11. An electroluminescent touch display according to claim 10, wherein:
the thin film element comprises two or more segment electrode groups (A′, B′) associated with the two or more touch electrode groups (A, B), the two or more segment electrode groups (A′, B′) comprising the segment electrodes, and
the electroluminescent touch display is arranged to drive the segment driving signal to the segment electrodes in the segment electrode group (A′, B′) and to drive the common driving signal to the one or more common electrodes.

12. An electroluminescent touch display according to claim 11, wherein:
an area spanned by the touch electrodes of each of the touch electrode groups (A, B) does not overlap an area spanned by the segment electrodes of each of the associated segment electrode groups (A′, B′); or
a smallest distance between an area spanned by the touch electrodes of each of the touch electrode groups (A, B) and an area spanned by the segment electrodes of each of the associated segment electrode groups (A′, B′) is at least 1 mm; or
a smallest distance between an area spanned by the touch electrodes of each of the touch electrode groups (A, B) and an area spanned by the segment electrodes of each of the associated segment electrode groups (A′, B′) is at least 5 mm.

13. An electroluminescent touch display according to claim 9, wherein:
the thin film element comprises organic luminescent material capable of light production when a voltage exceeding an organic threshold voltage is applied over the organic luminescent material; or
the thin film element comprises inorganic luminescent material capable of light production when a voltage exceeding an inorganic threshold voltage is applied over the inorganic luminescent material.

14. An electroluminescent touch display according to claim 9, wherein the electroluminescent touch display comprises a slider element arranged to input and output level related information, the slider element comprising at least three segment electrodes and at least two touch electrodes.

15. An electroluminescent touch display according to claim 9, wherein:
the electroluminescent touch display comprises a pin-pad element arranged to input and output alphanumeric information, the pin-pad element comprising at least three segment electrodes and at least three touch electrodes; or
the electroluminescent touch display comprises a pin-pad element arranged to input and output alphanumeric information, the pin-pad element comprising at least ten segment electrodes and at least ten touch electrodes; or
the electroluminescent touch display comprises a pin-pad element arranged to input and output alphanumeric information, the pin-pad element comprising at least twelve segment electrodes and at least twelve touch electrodes.

16. An electroluminescent touch display according to claim 9, wherein:
the thin film element is transparent; or
the electroluminescent touch display is transparent.

17. An electroluminescent touch display according to claim 9, wherein the electroluminescent touch display is driven with a method comprising:
a light excitation step, the light excitation step comprising driving a segment driving signal to the one or more segment electrodes and a common driving signal to the one or more common electrodes,
a touch indication step, the touch indication step comprising detecting if any of the two or more touch electrodes is touched, and
a touch determination step, the touch determination step comprising determining which of the two or more touch electrodes is touched, such that
if any of the two or more touch electrodes is touched as indicated by the touch indication step, the touch determination step is executed, and
if none of the two or more touch electrodes is touched as indicated by the touch indication step, the touch determination step is left unexecuted.
